(19) United States
(12) Patent Application Publication
(10) Pub. No.: US 2015/0019470 A1
(43) Pub. Date: Jan. 15, 2015

(54) CLINICAL DECISION SUPPORT SYSTEM AND DEVICE SUPPORTING THE SAME

(71) Applicants: GIL MEDICAL CENTER, Incheon (KR); BRC Co,. Ltd., Incheon (KR)

(72) Inventors: Dong Kyun PARK, Incheon (KR); Eun Young JUNG, Incheon (KR); Byoung Hui JEONG, Incheon (KR); Jae Kwon KIM, Incheon (KR); Yong Su LIM, Incheon (KR)

(73) Assignees: GIL MEDICAL CENTER, Incheon (KR); BRC Co,. Ltd., Incheon (KR)

(21) Appl. No.: 14/013,001

(22) Filed: Aug. 28, 2013

(30) Foreign Application Priority Data
Jul. 11, 2013 (KR) 10-2013-0081422

(51) Int. Cl. G06N 5/04; G06N 5/02

(52) U.S. Cl. CPC G06N 5/048; G06N 5/02
USPC 706/47

(57) ABSTRACT

A clinical decision support system provides a process of multiple data collection related to the targeted disease, a process of collecting the first rule based on the clinical knowledge on the above targeted disease, a process of collecting the second rule with application of decision making tree on the above multiple data, a process of deriving the first probability of testing data using the above first rule and fuzzy function, a process of deriving the second probability with application of above testing on the above second rule and a process of integrated analysis suggesting the risk level of targeted disease by deriving the integrated analysis data through integrated analyzing on the above first probability and second probability data.

### CROSS-REFERENCE TO RELATED APPLICATIONS

The present application claims priority of Korean Patent Application No. 10-2013-0081422, filed on Jul. 11, 2013, which is incorporated herein by reference in its entirety.

### BACKGROUND

1. Field

This invention is regarding to the clinical decision support system and device supporting the same. More particularly, it is regarding to a the clinical decision support system and device supporting the same to shorten the consulting time between doctor and patient and to reduce the medical cost of patient by supporting the decision on the exact state of patient.

2. Description of the Related Art

The state of the patient shall be decided after consulting with the patient in the hospital. At this time, it is a very important matter to identify the state of the patient precisely based on various personal information and consulting information.

For example, the patient may save the time owing to the no requirement of unnecessary operation when the state of patient is identified precisely and the unnecessary expenditure can be controlled. In addition, the patient may concentrate on the essential operation and additional treatment through exact identifying on the patient's condition.

For these advantages, an effort was made to analyze and identify the patient's condition more precisely traditionally.

But it was difficult to identify the objective and proper conditions of the patients because it tended to rely on the career of doctor who examines the patients simply to identify the patient's conditions traditionally. Moreover, it was difficult to provide appropriated medical service due to the big deviation on the identification of patient's condition depending on the doctor's career.

### SUMMARY

Various embodiments are directed to an analog-to-digital conversion circuit, an image sensing circuit, and a method for driving an image sensing circuit, capable of providing a high-speed operation. The present invention was suggested to solve the described traditional problem and the objective of this invention is to provide the clinical decision support system and device supporting the same for identification of more precise patient conditions.

In an exemplary embodiment of the present invention the present invention schematically shows the constitution of clinical decision supporting method including a process of multiple data collection related to the targeted disease, a process of collecting the first rule based on the clinical knowledge above targeted disease, a process of collecting the second rule with application of decision making tree on the above multiple data, a process of deriving the first probability of testing data using the above first rule and fuzzy function, a process of deriving the second probability with application of above testing on the above second rule and a process of integrated analysis suggesting the risk level of targeted disease by deriving the integrated analysis data through integrated analyzing on the above first probability and second probability data.

The above multiple data herein are for Personal Health Records (PHR) from the patients with cardiovascular disease. The above PHR data may include at least one attribute data out of the sex, age, total cholesterol, cholesterol included into the high-density lipoprotein cholesterol, systolic blood pressure, diabetics and smoking.

The above fuzzy function may include the fuzzy membership function for each attribute data for the above PHR data.

The above integrated analysis process may be performed based on Dempster-Shafer algorithm and the risk level of cardiovascular disease can be suggested with Very High, High, Moderate and Love depending on the above integrated analysis results.

The present invention schematically shows a constitution of clinical decision making support system including a multiple data related to the targeted disease, a first rule based on the clinical knowledge on the above targeted disease, a saving part for the second rule with application of decision making tree on the above multiple data, a derivation of the second probability of the data to be tested by using the above first rule and a fuzzy function and a control part suggesting the risk level of targeted disease by deriving the integrated analysis data of the first and second probability after deriving the second probability data with application of the above data to be tested on the above second rule.

According to the clinical decision support system and device supporting the same of the present invention, the present invention may support the decision on more precise conditions of patients.

In addition, it brings forth the effect of reducing the unnecessary medical expenditure from the patient through supporting more precise conditions of patient.

The precision decision on the patient's conditions may reduce the time of examination on the patient by the doctor and it has an effect of enhancing the productivity of medical service to shorten the examination time compared to the cost by reducing unnecessary examination time.

### BRIEF DESCRIPTION OF THE DRAWINGS

FIG. 1 is a drawing presenting the configuration of clinical decision support device according to the embodiment of the present invention.

FIG. 2 is a drawing describing more details on the configuration of control part in FIG. 1.

FIG. 3 is a drawing describing more details on the rule creation part in FIG. 2.

FIG. 4 is a drawing describing more details on the configuration of result expecting part in FIG. 2.

FIG. 5 is a drawing describing the fuzzy membership function to the age.

FIG. 6 is a drawing describing the fuzzy membership function to the total cholesterol.

FIG. 7 is a drawing describing the rule creation method out of the clinical decision making supporting methods according to the embodiment of the present invention.

FIG. 8 is a drawing describing the experiment and evaluation method on specific PHR data out of the clinical decision making supporting methods according to the embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, various embodiments for the present invention are explained based on the attached drawing in detail. The art which is known widely to the technology part and not related to the present invention directly is cancelled for explanation. In addition, the details of explanation for the components with same configuration and function practically are cancelled.

By the same reason, a part of the components is omitted or depicted schematically in the attached document and the size of each component does not reflect the real size entirely. Accordingly, the present invention is not united by the relative size and gap drawn on the attached drawing.

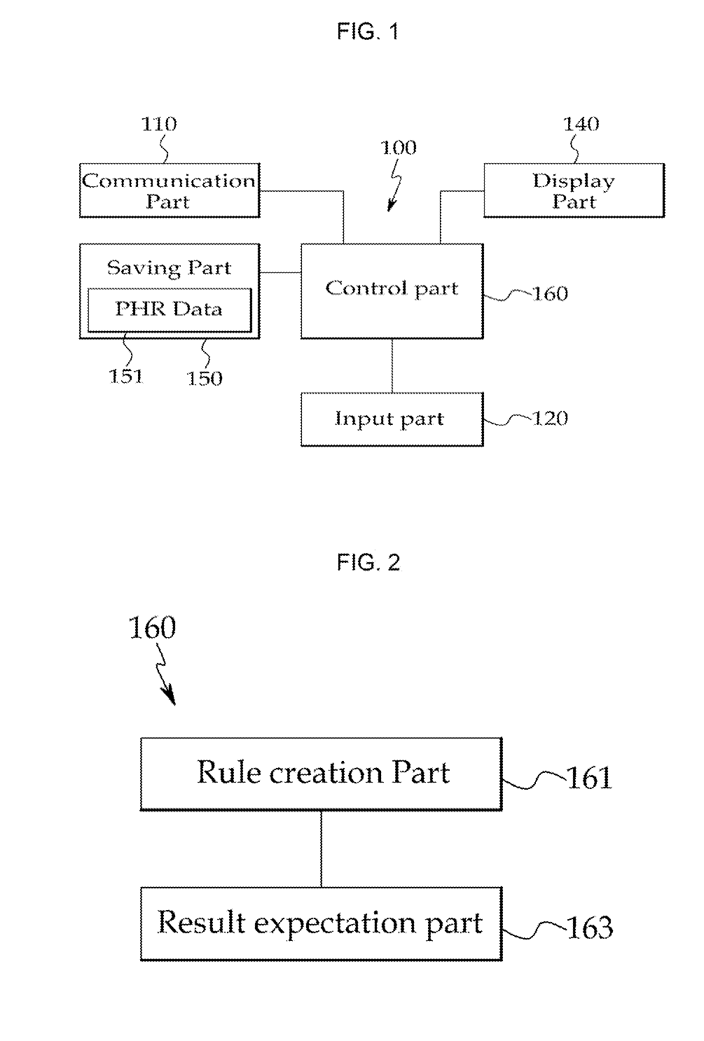

FIG. 1 is the drawing presenting the configuration of the components for the clinical decision making according to the embodiment of present invention.

Referring to the FIG. 1, the clinical decision support device 100 of the present invention may include the communication part 110, input part 120, display part 140, saving part 150 and control part 160.

The clinical decision support device 100 of the present invention which includes said configuration can collect the Personal Heath Records (PHR) data from at least either of the communication part 110 and input part 120.

The PHR data may include 7 basic data for the sex, age, total cholesterol, systolic blood pressure, diabetics and smoking as basic data related to the cardiovascular disease. The type and quantity of the above basic data may be differed by the kinds of disease and designer's intent to be applied to the clinical decision support device.

The improved precision for the level of disease may be provided through integrated analysis on the probability data for the level of derived disease based on the second rule of decision making tree created from the pre-defined first role based on the clinical knowledge and collected PHR data in relation to the targeted disease. Hereinafter, the role and function each component for the clinical decision making support of the present invention is explained.

The communication part 110 may support the communication function of the clinical decision support device 100. Especially, the communication part 110 may receive the data for clinical decision making for present invention. Here, the data can be the information on the state of the various patients with specific diseases. For example, the communication part 110 may receive the PHR data set related to the cardiovascular disease.

In addition, the communication part 110 may receive the first rule information based on the clinical knowledge. The first rule based on the clinical knowledge may be the converted data for deciding the disease by the specialist on the corresponding disease in analytical type by the clinical decision support device 100. The first rule may be configured to derive the probability with application of fuzzy membership function for the state of the patients based on the basic data described in advance for example.

The communication part 110 may transmit the integrated analysis data on the calculated probability by the first and second rules to a certain electronic device. For this matter, the communication part 11 may create the communication channel with other pre-defined electronic device or designated by the user manipulation and transmit the analyzed results.

The input part 120 may create the various input signals for the operation of the clinical decision support device 100. For example, the input part 120 may create the input signal for application program activation to support the clinical decision making support of present invention depending on the user manipulation.

The input part 120 may input the required various data input for the operation of the clinical decision making support program. For example, the aforesaid PHR data may be input depending on the user manipulation.

In addition, the input part 120 may create the input signal for searching the clinical decision making results depending on the user manipulation. This input part 120 may include the hardware devices such as keyboard and mouse. In addition, in case of providing the touch screen function on the display part 140, the display part 140 may be included to the input part 120 configuration.

The input part 120 may include the interface to connect the external electronic device or external saving device. The PHR data saved into the external electronic device or external saving device may be provided to the control part 160 through the input part 120.

The display part 140 may provide the various screens necessary for the operation of clinical decision support device 100. For example, the display part 140 may output the starting screen of clinical decision support device 100 and screen depending on the specific user function operation. The display part 140 may include the display panel and touch panel in case of provision in touch screen type.

The display part 140 may provide the screen for supporting the clinical decision making function according to the embodiment of present invention. For example, the display part 140 may display the information regarding to the first rule. In addition, the display part 140 may display the information on the second rule.

The display part 140 may output the calculated integrated analysis data according to the first and second rules. The integrated analysis result shown on the display part 140 may be displayed with the data of constant ratio.

The cases of clinical decision making function according to the embodiment of the present invention explain the level of cardiovascular disease for samples. Accordingly, the display part 140 may display the certainty data and probability data on the level of cardiovascular disease of the corresponding patient when the PHR data of a certain patient is input.

The saving part 160 may save various programs and data necessary for the operation of the clinical decision support device 100. For example, the saving part 160 may save the operation system of the clinical decision support device 100. In addition, the saving part 160 may save the application program corresponding to various functions supported by the clinical decision support device 100. The saving part 160 may save the created or externally received data depending on the operation of the functions on the clinical decision support device 100.

Especially, the saving part 160 may save the programs and PHR data 151 for supporting the clinical decision making function. The saving part 160 may include the first role collection program, the second rule creation program and PHR data collection program for supporting the clinical decision making function.

The saving part 160 may save the routines to display the integrated analysis algorithm and calculated data on the display part 140 to analyze the calculated rule data integrally according to the probability data calculated with the first and second rule. Here, the first rule may be the rule information provided by the specialist with specialized knowledge on a certain disease. The second rule may be the rule calculated by applying the multiple PHR data 151 to the fuzzy function. The integral analysis algorithm may be the Dempster-shafer algorithm.

The PHR data 151 may have the attribute data as shown in Table 1,

TABLE 1

| Attribute | Description | Type |
|---|---|---|
| Sex | Sex | [1, 2] |
| Age | Age | Integer |
| Total | Total cholesterol included | Double |
| Cholesterol | into the blood serum | |
| HDL | Chotesterol included in | Double |
| | the high-density | |
| | lipoprotein cholesterol | |
| SBP | Systolic blood pressure | Double |
| Diabetic | Diabetics | [Y, N] |
| Smoker | Smoking/Non smoking | [Y, N] |
| CVD Risk | Level of cardio vascular risk | [Very_High, High, |
| | | Moderate, Low] |

As it was shown in Table 1, the attributes of PHR data 151 applied to the clinical decision making function of present invention can be 7 in total. The level of cardiovascular disease risk corresponding to the data based on 7 PHR data can be evaluated in 4 steps of Very High, High, Moderate and Low.

The PHR data 151 was collected from 299 patients to apply the function of clinical decision making of present invention 210 patients out of 299 patients were used for the training set to create the second rule. The data from remaining 89 patients were used for experiment and evaluation. The experiment was made for 300 patients to perform the experiment within the restricted resources of the present invention, but the renewal of the training set information may be performed based on the data from more patients. In this case, the clinical decision making method of the present invention and the precision of the device may be improved gradually.

The control part 160 may support the signal processing and data delivery necessary for the clinical decision support device 100. Especially, the control part 160 may have the process for supporting the clinical decision making function of the present invention. The control part 160 may create the first and second rules by using the specifically described processor and provide the integrated analysis result from a certain PHR data. For this, the control part 160 may include the configuration schematically shown in FIG. 2˜FIG. 4.

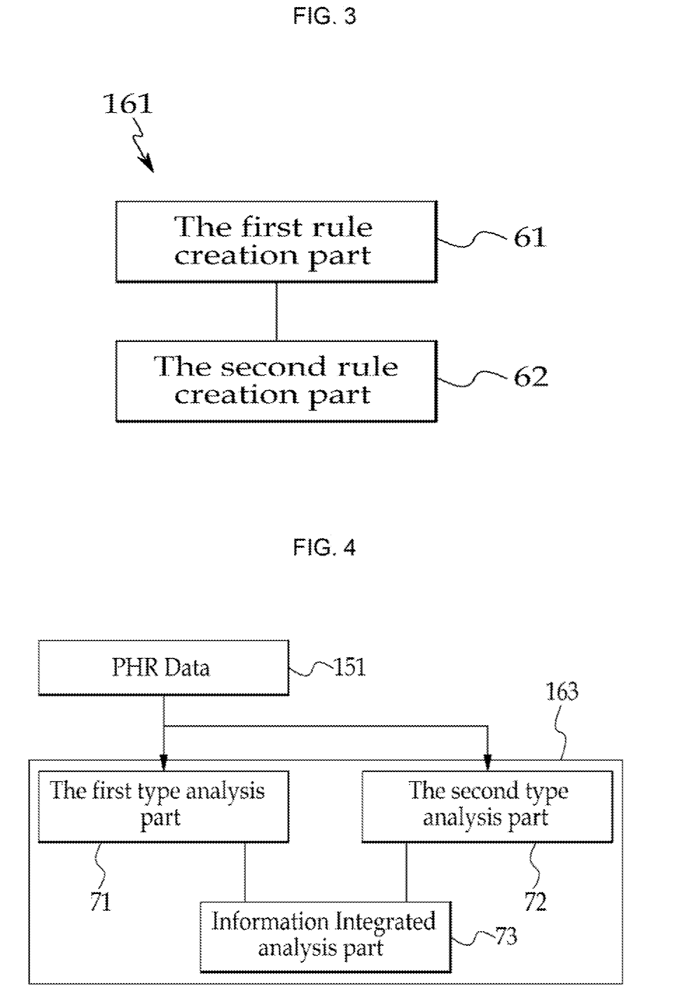

FIG. 2 is a drawing for the details of the control part 160 configuration out of the clinical decision support device 100 configuration according to the embodiment of present invention. FIG. 3 is the more specific configuration of rule creation part 161 in FIG. 2. FIG. 4 is the more specific configuration of the result expectation part 163.

Referring to the FIG. 2 firstly, the control part 160 of the present invention may include the rule creation part 161 and result expectation part 163.

The rule creation part 161 may create the rules required in the course of supporting the clinical decision making function. Especially, the rule creation part 161 may create the first and second rules as explained in the above. For this matter, the rule creation part 161 may include the first rule creation part 161 and the second rule creation part 62.

The first rule creation part 161 may be the processor controlling the saving the first rule to the saving part 160 of clinical decision support device 100. Such first rule creation part 161 may collect the first rule information made by the specialist for the specific medical field. For this matter, the first rule creation part 161 may control to create the communication channel with the other electronic device saved the first rule information made by the specialist for a certain medical part. The first rule creation part 161 may receive the first rule information for other electronic device depending on the user control. The first rule creation part 161 may control to save the first rule information to the saving part 160.

On the other hand, the first rule creation part 161 may collect multiple first rule information made based on various clinical knowledge related to the specific disease part and create the first rule by gathering the relatively high reliable sub rules out of the collected rule information.

For example, the first rule creation part 161 may collect the first rule information made by many specialists for specialized medical field. And the first rule creation part 161 may extract the common sub rules out of the multiple first rule information and create the first rule by using the extracted sub rules. The first rule creation part 161 may create the first rule based on the clinical knowledge generally approved many specialists.

On the other hand, the first rule creation part 161 may complement the sub-rule of the first rule while it processes the uncommon information out of multiple first rule information. For example, the first rule creation part 161 may control the sub-rules deriving the different data through comparing the first rule information not to use the first rule creation.

Otherwise, in case of existing the sub rules with different data, the first rule creation part 161 may choose the sub-rules with data derived by more specialists relatively. The first rule creation part 161 may control the non-cross unique sub-rules among the rule information to be included to the first rule.

The first rule creation part 161 may create the first rule based on the general sub-rule through this process and control to complement the special cases.

The examples of a part of the first rules created by the first rule creation part 161 based on the clinical knowledge were shown in Table 2. 52 sub-rules of the first rule were applied to the clinical decision making function of the present invention. The first rule may include more sub-rules or less sub-rules than the cases of changing the attribute data applied to the PHR data 151.

TABLE 2

| No | Rule |
|---|---|
| 1 | if Sex is Men and Age is less-Mid-Age Then Low |
| 2 | if Sex is Men and age is Less-Old Then High |
| 3 | if Sex is Men and age is Old Then Very High |
| 4 | if HDL is Low Then Moderate |
| 5 | if HDL is High Then Moderate |
| 6 | if Sex is Men and Total-Co is Very-Low Then Low |
| 7 | if Sex is Men and Total-Co is Low Then Moderate |
| 8 | if Sex is Men and Total-Co is High Then High |
| 9 | if Sex is Men and SBP is Mid Then Low |
| 10 | if Sex is Men and SBP is High Then High |
| 11 | if Smoker is Yes Then High, Very_High |
| 12 | if Diabetic is No Then Risk is Low |

The sub-rules shown in Table 2 may be a part of the sub-rules included into the first rules. The score can be decided depending on the fuzzy function input processing when these sub-rules are constituted.

The second rule creation part 162 may create the second rule to be used for the clinical decision making function of present invention. For this matter, the second rule creation part 162 may use the computing module performing the decision making tree algorithm. For example, the decision making tree with application of the clinical decision making supporting of the present invention used the computing module realized with C5.0 of SPSS Clementine 12.1. The second rule creation part 162 may constitute the second rules by selecting the rule base with highest probability depending on the hales created form the corresponding computing module.

When it is explained more specifically, the second rule creation part 162 may provide a part of PHR data defined as the training set from the saved PHR data 151 into the saving part 160 to the corresponding computing module after activating the computing module realized with C5.0 model. The second rule creation part 162 may collect the second rules by using the decision making tree data calculated by the computing module.

In the other words, the second rules for the relation between the basic state of the actual patients and the cardiovascular disease may be collected through comparing the PHR data 151. A part of sub-rules from such collected the second rules were shown in Table 3.

TABLE 3

| No | Rule |
|---|---|
| 1 | if age <= 64 and hdl > 42 and sbp <= 118 |
| | and dia = N and smo = N then Low |
| 2 | if age <= 67 and sbp > 130 then High |
| 3 | if age > 67 and hdl > 42 and sbp <= 130 |
| | and smo = Y then Moderate |
| 8 | if sex = 1 and age <= 64 and hdl <= 42 |
| | and sbp <= 118 and smo = N then Moderate |
| 10 | if sex = 1 and age > 55 |
| | and sbp > 130 then Very_High |
| 11 | if sex = 1 and age > 64 |
| | and dia = Y then Very_High |
| 12 | if sex = 1 and age > 64 and hdl > 48 and |
| | sbp <= 124 and dia = N and smo = N then High |
| 17 | if sex = 1 and age > 70 |
| | and hdl <= 46 then Very_High |
| 21 | if sex = 2 and age > 64 and hdl > 42 |
| | and sbp <= 124 and dia = N and smo = N then Low |

The abbreviations used in Table 3 may be the data corresponding to the attribute data of the PHR data 151 explained in Table 1. Namely, hdl is the HDL in Table 1, sbp is the SBP in Table 1, dia is the Diabetic in Table 1, and smo may correspond to the Smoker in Table 1. When the sex is 1, it is male and sex 2 may correspond to the female. Y corresponds to “Yes” and “N” corresponds to “No.”

The result expectation part 163 may be a configuration to forecast the level of risk for a certain disease from the experiment and evaluation data out of PHR data 151 by using the rules created by rule creation part 161. For this matter, the result expectation part 163 may include the first type analyzing part 71, second type analyzing part 72 and information integrated analysis part 73.

The first type analyzing part 71 derives the probability data for specific PHR data by using the first rule created by the rule creation part 161 and fuzzy function. Namely, the first type analyzing part 71 may constitute the fuzzy membership function by using the data attribute data provided with training set out of the first rule and PHR data 151.

The first type analyzing part 71 may derive the probability for each attribute of PHR data to be experimented and evaluated by using the created fuzzy membership function.

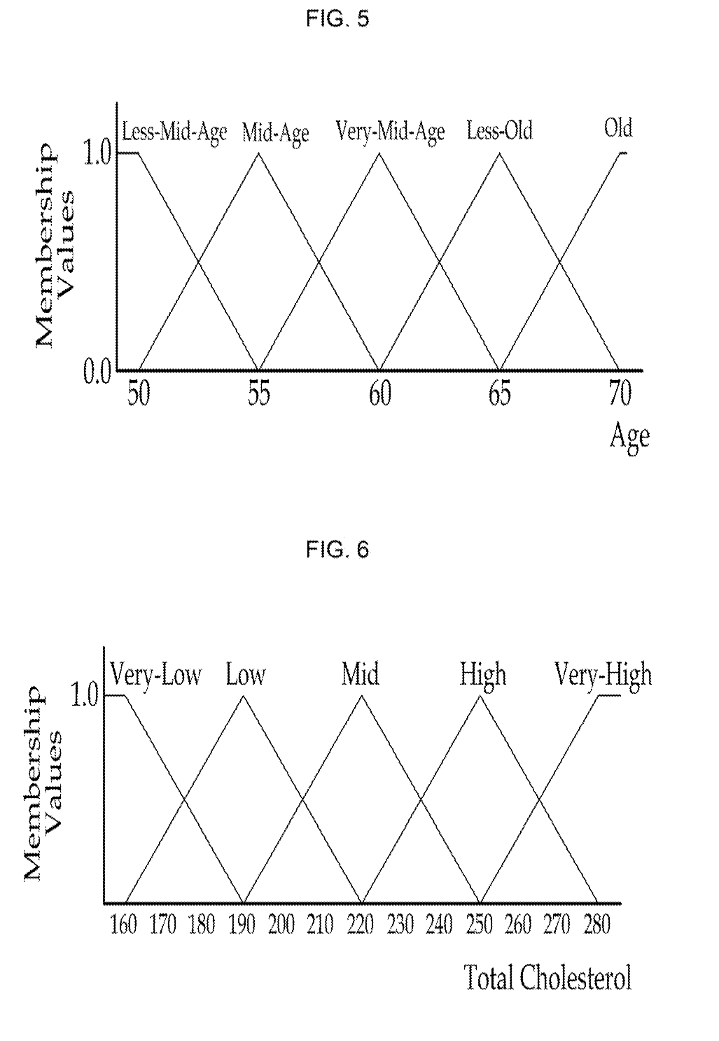

The fuzzy membership function for the age and total cholesterol out of the fuzzy membership functions created by the first type analyzing part 71 was shown in FIGS. 5 and 6. For example, the membership data may be Very Low=0.25 and Low=075 in case of 180 total cholesterol in PHR data when it is assumed that the fuzzy membership function is derived from the total cholesterol shown in FIG. 6. The first type analyzing part 71 of the present invention may operate the fuzzy membership function for 7 attribute date explained in Table 1.

The probability of the cardiovascular risk may be expected through the following mathematical formula I when the probability for the entire attribute data is obtained.

$$CVD is low = {\sum }_{i = 1}^{N} Input {( Low )}_{i} / N \\ CVD is moderate = {\sum }_{i = 1}^{N} Input {( Moderate )}_{i} / N \\ CVD is High = {\sum }_{i = 1}^{N} Input {( High )}_{i} / N \\ CVD is VeryHigh = {\sum }_{i = 1}^{N} Input {( VeryHigh )}_{i} / N \qquad [ Mathematical equation 1 ]$$

N in the mathematical formula I may mean the entire input data.

The output data from fuzzy membership function is in between 0˜1 which may be the probability for the corresponding input PHR data. The first type analyzing part 71 may derive the probability for 7 attribute data of PHR data by using the specified fuzzy membership function. The first type analyzing part 71 may forecast the probability of cardiovascular risk for a certain PHR data 151 compared with the entire PHR data or training set data through the specifically described procedures.

The second type analyzing part 72 may forecast the cardiovascular risk for a certain PHR data by applying the second rule. For this matter, the second type analyzing part 72 may estimate the PHR data input by using the second rule created through the decision making tree. More than 2 rules for a certain PHR data may be applied. In this case, the second type analyzing part 72 may decide the entire probability of the cardiovascular list with the same manner in mathematical equation 2.

$$Count ( L ) = {\sum }_{R = 1}^{N} {( IF ( Riskis Low ) Then 1 )}_{R} \\ Count ( M ) = {\sum }_{R = 1}^{N} ( IF ( Riskis Moderate ) Then 1 ) \\ Count ( H ) = {\sum }_{R = 1}^{N} {( IF ( Riskis High ) Then 1 )}_{R} \\ Count ( VH ) = {\sum }_{R = 1}^{N} {( IF ( Riskis VeryHigh ) Then 1 )}_{R} \\ Z = Count ( L ) + Count ( M ) + Count ( H ) + Count ( VH ) \\ CVD is Low = Count ( Low ) / Z \\ CVD is Moderate = Count ( Moderate ) / Z \\ CVD is High = Count ( High ) / Z \\ CVD is VeryHigh = Count ( VeryHigh ) / Z \qquad [ Mathematical equation 2 ]$$

Here, the count (Risk name) presents the each result out of the count of the results estimated through the second rule and Z may be all counts. The second type analyzing part 72 may forecast the probability of cardiovascular risk of each PHR data by using Z data.

The information integrated analysis part 73 may analyze the first probability from the first type analyzing part 71 and the second probability from the second type analyzing part 72 integrally. Especially, the information integrated analysis part 73 may derive the integrated analysis result by applying the Dempster-Shafer algorithm for the first and second probability. For this matter, the clinical decision support device 100 may include the computing module for Dempster-Shafer algorithm operation. And then, the information integrated analysis part 73 derives the integrated analysis result by applying the first and second probability to the Dempster-Shafer algorithm module.

The information integrated analysis part 73 may calculate the probability of the set not belonged to the cardiovascular risk forecast result in the estimation of the first and second rule for deriving the integrated analysis result with same procedure in mathematical equation 3.

$${m}_{1} ( φ ) = 1 - ( {m}_{1} ( Low ) + {m}_{1} ( Moderate ) + {m}_{1} ( High ) + {m}_{1} ( VeryHigh ) ) \\ {m}_{2} ( φ ) = 1 - ( {m}_{2} ( Low ) + {m}_{2} ( Moderate ) + {m}_{2} ( High ) + {m}_{2} ( VeryHigh ) ) \qquad [ Mathematical equation 3 ]$$

Here, m1 is the estimated from the first rule and m2 may mean the set estimated from the second rule. The m for the empty set is mapped to the probability of “)” and the Low level forecasting method for the cardiovascular risk out of the set which is not belonged and Dempster-Shafer algorithm module result data for the forecast result may be calculated like the procedures in mathematical equation 4 as follows.

$${m}_{3} ( Low ) = {m}_{1} ⊕ {m}_{2} ( Low ) = \frac{{\sum }_{L ⋂ M ⋂ H ⋂ VH = L} {m}_{1} ( Low ) {m}_{2} ( Low )}{{\sum }_{L ⋂ M ⋂ H ⋂ VH = Ø} {m}_{1} ( Low ) {m}_{2} ( Low )} \qquad [ Mathematical equation 4 ]$$

The information integrated analysis part 73 may obtain the data for Bel and Pls through m3 in the mathematical equation 4. The cardiovascular risk level may be forecast through this.

When the Dempster-Shafer is explained in more details, Dempster. Shafer evidence theory (It is called as D-S theory hereinafter.) had been developed by Glenn Shafter in 1976 by the suggestion of Arthur Dempster in 1967. The certainty level is presented with the interval in this principle and the addition of P(H) and P( [symbol] H) need not to be 1 in any case. This is called as an environment. The environment is a set for the interested objects. For example, the environment, θ can be set as same with the mathematical formula 5 as follows.

θ={Very High,High,Moderate,Bad,Very Bad} [Mathematical equation 5]

As it is shown in the examples of the elements in the mathematical equation 5, each element constituting the environment is exclusive each other. The environment θ may have the sub set. When θ is same with the mathematical equation 5, all in the following mathematical formula 6 are the sub-sets.

θ₁={Very High,High}

θ₂={Very High}

θ₃={High,Moderate,Bad}

θ₄={Ø}

θ₅={Very High,High,Moderate,Bad,Very Bad} [Mathematical equation 6]

Each sub-set may be interpreted with the answer to each question. Namely, the responding with θ₁ to the questioning the character of a person and it may be answered with θ₂. The case of empty set like θ₄ is no answering. The each element of θ can be a possible answer, such θ of answering with single element is defined as frame of discernment. It is called as frame of discernment in English. Here, adopting the word of discernment (Distinction or determination) means that an element can be an answer by differentiating with other element. Namely, rather ambiguous answering can be avoided such as “High” or “Moderate” because the “High” or “Moderate” can be classified for the character of a certain person.

When θ is made of n elements, the sub-set of the θ is counted as 2ⁿ including the Ø and θ itself. The set made of all 2ⁿ sub-set is called as the power set of θ and it is expressed with Θ. An evidence may make influence on the level of belief to a certain sub-set of these power sets. Such level of belief is expressed with the value between 0 and 1. The function of mapping with [0, 1] at the element of such Θ is called as basic probability assignment (B.P.A) and it is expressed as m and it is characterized with the following mathematical equation 7.

$$m \text{:} {2}^{k} \to [ 0 , 1 ] \\ m ( Ø ) = 0 , \\ \text{?} m ( A ) = 1 \\ \text{?} \text{indicates text missing or illegible when filed} \qquad [ Mathematical equation 7 ]$$

The m for the empty set is 0 and the sum of m for all elements of power set Θ of θ is 1. Here, the sub-set of Θ with value of m bigger than 0 is called as focal element. The Belief, Bel(S) for the focal element, S is defined as the following mathematical equation 8.

$$Bel ( S ) = \text{?} m ( h ) \\ \text{?} \text{indicates text missing or illegible when filed} \qquad [ Mathematical equation 8 ]$$

For example, when it is believed as “Very High” and “High” for the character of a person by checking a certain evidence, S={Very High, High} and the Bel(S) becomes the sum of m for {Very High}, {High} and {Very High, High}. However, the belief on the focal element is not expressed with only Bel simply, but it is expressed with a single interval. This interval is called as an evidential interval. The smaller one in the belief interval for focal element, S for certain evidence becomes the data for Bel(S) and the bigger one becomes the data for PIs(S) as a plausibility of S, and PIs(S) is defined as the following mathematical equation 9.

PIs(S)=Bel( [symbol] S) [Mathematical equation 9]

Here, [symbol] S is the complementary set of S. Namely, when S={High}, the Bel(S)=0.2 and evidential interval becomes in between 0.2-0.7 when Bel( [symbol] S)=0.3. Here, 0.7 present the level of plausibility because it becomes the part of disbelief as 0.2 is the part for positive assurance and 0.3 is the positive disbelief. The evidential interval has the following meaning depending on the interval range.

The D-S principle is differed from the probability theory. In D-S principle, the m value for the positive meaning is assigned only for the hypothesis created the belief and the value is not assigned forcibly for the part which is not. When the sum of the assigned value is not 1, the other part becomes the part of no belief or not known by assigning to the environment θ.

Next, the procedures of combining the different data of m are explained. When the different values for m are created for the same θ, it is needed to combine these. For example, when the different result data of m1 and m2 are given, the combined arithmetics, ⊕ for the belief by these two evidences are decided to the following mathematical equation 10.

m1⊕m2(Z)=Σm1(X)m2(Y),X∪Y=Z [Mathematical equation 10]

Here, the common part of Z for X and Y will grant the value for new belief. The empty set will receive the multiplication of values of m when there is no common element in the combining of two sets. In addition, the intersection with θ becomes the set itself combining with θ.

But the problem is that the empty set has the value of m which is not 0 here. In order to solve this problem, the value of m for an empty set shall be made to 0 forcibly and the value of m of the other focal elements shall be divided with 1−m({φ}) in the meaning of amplification proportionally to the value of m which was the value of empty set. This procedure is called as normalization.

For example, when the PHR data for the patient with the data of female for sex, 230 for cholesterol, HDL 61, SBP 114, non-smoker and no diabetics are input to the clinical decision support device 100 of present invention, the level of cardiovascular risk may be derived with Low=0.514, Moderate=0.152, High=0.190, Very_High=0.0 according to the first rule analysis. And the results of Low=0.5 Moderate=0.0, 2High=0.5 Very_High=0.0 can be derived when the specifically describe PHR data is analyzed according to the second rule.

Namely, the weight value on the result for Low is high in terms of the first rule analysis, the weight value for Low and High was highly evaluated in terms of the second rule analysis. In case of integrated analysis on the first rule and the second rule to solve the uncertainty for the result of the second rule analysis, the results shown in Table 4 can be derived.

TABLE 4

| Item | m2(Low) | m2(High) |
|---|---|---|
| m1(Low) | 0.257 | 0.2571 |
| m1(Moderate) | 0.076 | 0.0762 |
| m1(High) | 0.095 | 0.0952 |
| m1(Ø) | 0.071 | 0.0714 |

Finally, Bel and PIs with application of D-S algorithm can be m3(Low)=[0.663, 0.337] and m3(High)=[0.337, 0.663] respectively. When the above example is considered based on the results from the clinical decision support device (100) of present invention, it can be decided that the patient with corresponding PHR data has the probability of Low in cardiovascular risk relatively.

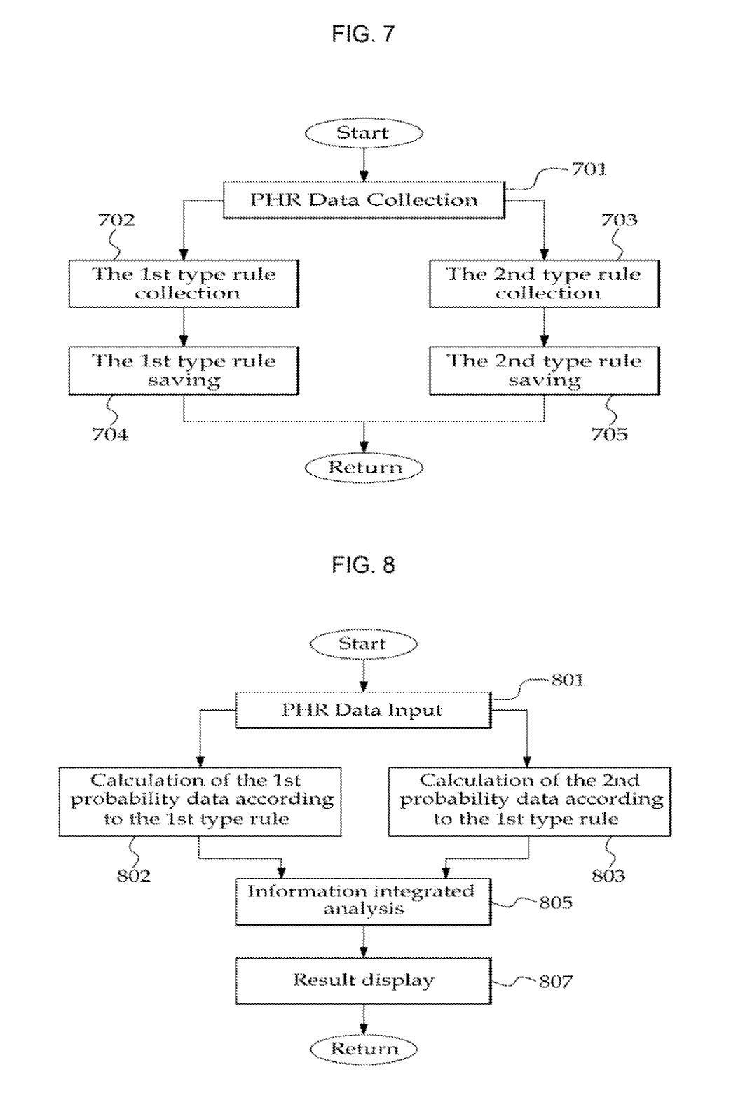

FIG. 7 is a drawing to describe the rule creation method out of the clinical decision making supporting methods according to the embodiment of present invention.

Referring to FIG. 7, the control part 160 of the clinical decision support device 100 may collect the PHR data from procedure 701. Here, PHR data may be the PHR data for the patient related to the specific disease to apply the clinical decision making function of present invention.

Next, the control part 160 may collect the first type rule from the operation procedure 702. Here, the first type rule may be a rule made by the specialist for the targeted disease part. The first type rule may be a rule classifying the level of risk for a certain disease in case of the patient with special conditions. The cardiovascular disease was shown as an example in the clinical decision making function of present invention and the level of risk was classified into 4 levels.

The control part 160 may save the first type rule in operation procedure 704. The first type rule may be renewed depending on the distribution of new clinical knowledge and clinical result collection.

On the other hand, the control part 160 may create the second type rule in operation procedure 703. The second type rule may be created as a result from the decision making tree by inputting the PHR data. For this matter, SPSS Clementine C5.0 model was taken as an example in present invention. The PHR data may be defined according to a certain rules through decision making tree. The control part 160 may save the second type rule in 705 operation procedure when the second type rule is derived depending on the definition of the rules.

The specifically described procedures of collection and saving of the first type rule and creation and saving of the second type rule are not restricted by the order of specific time. For example, the processing of the first type rule and the second type rule may be occurred concurrently or sequentially. The first type rule may be processed firstly in the sequential creation procedure too, otherwise, the second type rule may be processed firstly.

FIG. 8 is a drawing to explain the experiment and evaluation method for a certain PHR data out of the clinical decision making supporting method according to the embodiment of present invention.

Referring to FIG. 8, with regards to the clinical decision making supporting method of present invention, the clinical decision support device 100 may input specific PHR data to be experimented and evaluated in procedure 801 firstly. Here, the PHR data may be directly input or from other electronic device through the communication part 110 and input interface.

The clinical decision support device 100 may provide the input screen to input the attribute data for PHR data used for creation and saving respectively for PHR data input receiving. For example, the clinical decision support device 100 may provide the input screen for 7 attribute data described in Table 1 through the display part 140.

When the PHR data to be tested is input, the control part 160 of the clinical decision support device 100 may calculate the first probability data from procedure 802 depending on the first type rule. For this matter, the control part 160 may operate the first type analyzing part 71. The first type analyzing part 71 may calculate the probability data for each risk of PHR data by using the first rule saved into the saving part 160 and fuzzy function.

As the present invention suggest 4 classified data for cardiovascular disease, 4 probability data can be derived. When the classified data for a certain disease are more specified, the first type analyzing part 71 may derive the probability for more specifically classified data.

On the other hand, the control part 160 of clinical decision support device 100 may calculate the second probability according to the second type rule in procedure 803. For this matter, the control part 160 may calculate the probability for PHR data based on the second rule created through decision making tree. For example, the control part 160 may calculate the second probability through ratio arithmetics for a certain classified data compared to the application frequency of currently input PHR data.

Next, the control part 160 may analyze the information integrally on the first and second probability data in procedure 805. In this procedure, the control part 160 may operate Dempster-Shafer algorithm computing module. Namely, the control part 160 may provide the reliability and plausibility on a certain focal element as a random interval through combining the first and second probability data. Consequently, the control part 160 may support to make possible to estimate the reliability for the classified data of specific disease by providing the range of plausibility level and reliability level of specifically classified data.

Later, the control part 160 may output integrated analysis result through the display part 140 in procedure 807. In addition the control part 160 may control the integrated analysis result to be saved to the saving part 160. In addition, the control part 160 may control the integrated analysis result to be transmitted to the designated electronic device.

The accuracy was measured to evaluate performance of the forecast on the cardiovascular risk level based on the clinical decision support device 100 of the present invention. The fuzzy system (Rule 1), decision tree (Rule2), decision tree (C&R) and Apriori (GRI) were provided for reference group of the experiment.

The PHR data from 299 patients of cardiovascular disease in Gachon University Gil Medical Center were collected for experimental data. The data of 210 patients (Low for 89 patients, Moderate for 35 patients, High for 56 patients and Very high for 30 patients) were assigned to training set, and the data of 89 patients (Low for 39 patients, Moderate for 15 patients, High for 23 patients and Very high for 12 patients) were assigned to the testing set.

The results of measuring the precision were shown in Table 5.

TABLE 5

| Item | Accuracy (%) |
|---|---|
| Fuzzy Base System(Rule1) | 59.551 |
| Decision Tree(Rule2) | 60.674 |
| Decision Tree(C&R) | 59.551 |
| Apriori(GRI) | 55.056 |
| Propose Engine(this invention) | 67.416 |

As it was shown in Table 5, the accuracy of clinical decision making supporting device of present invention is 67.416%, and it was known as higher than other reference groups relatively.

On the other hand, the desired embodiments of present invention were explained through this description and drawings. Even though specific terminologies were used, but they were used for the general meaning to explain the art of present invention and to help the understanding on the invention and they were not intended to restrict the scope of present invention. The availability of modified embodiments based on the technological ideas of the present invention besides the invented embodiments herein is evident to the persons who have general knowledge on the technology part categorizing the present invention.

Although various embodiments have been described for illustrative purposes, it will be apparent to those skilled in the art that various changes and modifications may be made without departing from the spirit and scope of the invention as defined in the following claims.

What is claimed is:

1. A clinical decision supporting method, comprising:
a process of multiple data collection related to the targeted disease;
a process of collecting the first rule based on the clinical knowledge above targeted disease;
a process of collecting the second rule with application of decision making tree on the above multiple data;
a process of deriving the first probability of testing data using the above first rule and fuzzy function;
a process of deriving the second probability with application of above testing on the above second rule; and
a process of integrated analysis suggesting the risk level of targeted disease by deriving the integrated analysis data through integrated analyzing on the above first probability and second probability data.

2. The clinical decision supporting method according to claim 1, wherein the multiple data includes Personal Health Research (PHR) data for patients with cardiovascular disease.

3. The clinical decision supporting method according to claim 2, wherein the PHR data includes at least one attribute data out of the sex, age, total cholesterol, cholesterol included into the high-density lipoprotein cholesterol, systolic blood pressure, diabetics, and smoking.

4. The clinical decision supporting method according to claim 3, wherein the fuzzy function includes the fuzzy membership function for each attribute data for the above PHR data.

5. The clinical decision supporting method according to claim 1, wherein the clinical decision making supporting method characterized with a process performed based on Dempster-Shafer algorithm.

6. The clinical decision supporting method according to claim 1, wherein the integrated analysis process includes the suggestion with Very_High, High, Moderate and Low depending on the above integrated analysis results.

7. A clinical decision making support system, comprising:
a multiple data related to the targeted disease;
a first rule based on the clinical knowledge on the above targeted disease, a saving part for the second rule with application of decision making tree on the above multiple data;
a derivation of the second probability of the data to be tested by using the above first rule and a fuzzy function; and
a control part suggesting the risk level of targeted disease by deriving the integrated analysis data of the first and second probability after deriving the second probability data with application of the above data to be tested on the above second rule.

8. The clinical decision making support system according to claim 7, wherein the multiple data includes Personal Health Research (PHR) data for patients with cardiovascular disease.

9. The clinical decision making support system according to claim 8, wherein the PHR data includes at least one attribute data out of the sex, age, total cholesterol, cholesterol included into the high-density lipoprotein cholesterol, systolic blood pressure, diabetics, and smoking.

10. The clinical decision making support system according to claim 8, wherein the fuzzy function includes the fuzzy membership function for each attribute data for the above PHR data.

11. The clinical decision making support system according to claim 7, wherein the control part combines the first derived data and the second derived data based on Dempster-Shafer algorithm.

12. The clinical decision making support system, according to claim 7, wherein the control part suggests Very_High, High, Moderate and Low for the cardiovascular risk level depending on the above integrated analysis results.
